(19) United States
(12) Patent Application Publication
(10) Pub. No.: US 2005/0010683 A1
(43) Pub. Date: Jan. 13, 2005

(54) Apparatus, system and method for performing table maintenance

(76) Inventors: Prabhanjan Moleyar, Bangalore (IN); Vishram Sarurkar, Bangalore (IN); Himanshu Goel, Ghaziabad (IN); Ajith Prasad, Bangalore (IN); Muralidharan Chilukoor, Bangalore (IN)

Correspondence Address: BUCKLEY, MASCHOFF, TALWALKAR LLC, 5 ELM STREET, NEW CANAAN, CT, 06840, US

(21) Appl. No.: 10/610,104

(22) Filed: Jun. 30, 2003

(51) Int. Cl. G06F 15/173

(52) U.S. Cl. 709/238

(57) ABSTRACT

A method, apparatus, and system for maintaining an uncorrupted table.

### BACKGROUND

In certain computer networks including, for example, the Internet, data structures and tables exist for holding data. That data may include tasks to be performed or data on which an action is to be taken. For example, an address table may include routing information for nodes having addresses that are coupled to the network. Accordingly, when a node transmits information, for example in Internet Protocol packet format, the table may be referenced to route the packets from the transmitting node to the receiving node.

### BRIEF DESCRIPTION OF THE DRAWINGS

The accompanying drawings, wherein like reference numerals are employed to designate like components, are included to provide a further understanding of the present table maintenance techniques, are incorporated in and constitute a part of this specification, and illustrate embodiments of table maintenance techniques that together with the description serve to explain the principles of the present table maintenance techniques.

In the drawings:

FIG. 1 is a block diagram of a network suitable for practicing an embodiment of table maintenance;

FIG. 2 is a device suitable for practicing an embodiment of table maintenance;

FIG. 3 is a block diagram of an embodiment of a table access control system;

FIG. 4 is a relevant history chart that illustrates a number of entries that were relevant for a media switch; and

FIG. 5 is another block diagram of information flow in an embodiment of table maintenance.

### DETAILED DESCRIPTION

Reference will now be made to preferred embodiments of the present table maintenance techniques, examples of which are illustrated in the accompanying drawings. Moreover, those of ordinary skill in the art will appreciate that the table maintenance techniques described in connection with an address table may be equally applicable to other tables including, for example, any table that may be corrupted due to multiple functions attempting to read from or write to that table in a short timeframe. Other details, features, and advantages of the table maintenance techniques will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

The Internet is a network of nodes such as computers, dumb terminals, or other typically processor-based, devices interconnected by one or more forms of communication media. Typical interconnected devices range from handheld computers and notebook PCs to high-end mainframe and supercomputers. The communication media coupling those devices include twisted pair, co-axial cable, optical fibers and wireless communication techniques such as use of radio frequency.

A node is any device coupled to the network including, for example, routers, switches, servers, and clients. Nodes may be equipped with hardware, software or firmware used to communicate information over the network in accordance with one or more protocols. A protocol may comprise a set of instructions by which the information signals are communicated over a communications medium. Protocols are, furthermore, often layered over one another to form something called a “protocol stack.” In one embodiment, the network nodes operate in accordance with a packet switching protocol referred to as the Transmission Control Protocol (TCP) as defined by the Internet engineering Task Force (IETF) standard 7, Request for Comment (RFC) 793, adopted in September, 1981 (TCP Specification), and the Internet Protocol (IP) as defined by IETF standard 5, RFC 791 (IP Specification), adopted in September, 1981, both available from www.ietf.org (collectively referred to as the “TCP/IP Specification”).

Nodes may operate as source nodes, destination nodes, intermediate nodes or a combination of those source nodes, destination nodes, and intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include data to be utilized by the node in which the data resides, data to be transferred to another node and utilized therein, and so forth.

A table on which the table maintenance may act may be referred to as a target table. A commonly used type of target table is an address table or address resolution table. Such an address table may include routing information for nodes having addresses that are coupled to the network. Such address tables frequently are situated in switches or routers in those networks that assist nodes in passing information such as Internet Protocol (IP) packets from a transmitting node to a receiving node. Thus, embodiments of table management will be described in connection with such an address table situated in a network router.

Various activities take place related to an address table. Certain of those activities may be described as address resolution, address table maintenance, and address re-stamping, and each of those functions may be viewed as being performed by a module; such that an address resolution module, an address table maintenance module, and an address re-stamping module will be considered herein.

The address resolution module may search for addresses in the address table. For example, when information is transmitted in packets, an address of a receiving node or a next hop node may have to be determined from the address resolution table for each packet transmitted. The speed at which such packets are transmitted is often important because, for example, a requestor at the receiving node may be waiting to receive information requested from the transmitting node. Thus, minimizing latency for such packet address resolution is important and such packet address resolution is given a high priority in comparison to other activities that may be requesting access to the table.

The address table maintenance module adds addresses to and deletes addresses from the address table. For example, an address that has recently been requested after not being requested for some time may indicate that a series of packets are being received from the new address and so that address should be added to the table to make for fast address resolution for packets that are being transmitted to that address. Moreover, when an address residing in the table has not been requested for a period of time, it may be assumed that current transmissions to that address are completed and that address may be removed from the table.

The speed at which the address table maintenance module adds address resolution entries to and removes address resolution entries from the table is generally less critical than the speed at which addresses for transmitted packets are looked-up or resolved because addition and removal only minimally affect the speed at which requested information reaches a requesting node or user information reaches a user. Thus, latency for such address table updating may be given a lesser priority in comparison to address resolution functions.

The address re-stamping module may mark or re-stamp, addresses either as active or idle, with active addresses being those that have been accessed from the table within a predefined time period and idle addresses being those that have not been accessed from the table within that predefined time period. That module may have the lowest priority of the three modules discussed and the least latency minimization requirement.

As may be recognized, the address resolution module, the address table maintenance module, and the address re-stamping module may each be attempting to access the address table at any time. Other modules may also attempt to access the address table at any time. Furthermore, corruption of the address table may occur when more than one module is in contention for access to the address table as, for example, each module may read from or write to an entry in the table simultaneously or nearly simultaneously, thereby possibly corrupting that entry. Moreover, it is important for the address table to be uncorrupted and for each module to work with an address table that is consistent with the address table each other module is working with. Thus it is desirable to have an arbiter to control module access to the address table.

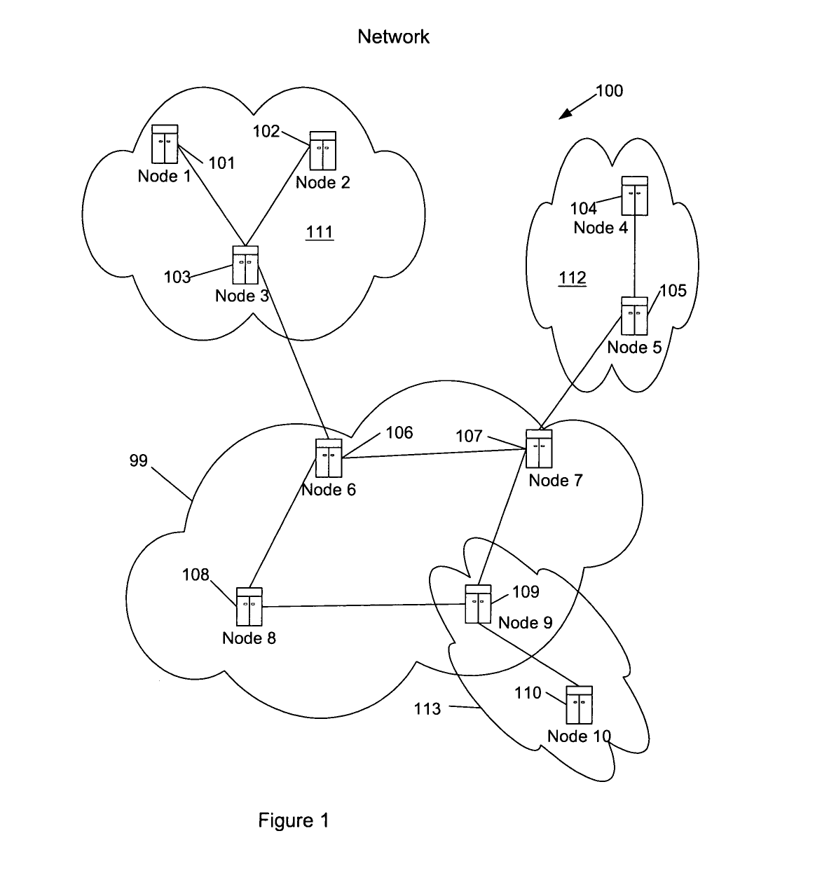

FIG. 1 illustrates an embodiment of a network 100 in which an embodiment of the address table maintenance system may be implemented. Node 1 101, node 2 102 and node 3 103 are nodes in area 1 111 of the network 100. Node 4 104 and node 5 105 are nodes in area 2 112 of the network 100. Node 9 109 and node 10 110 are nodes in area 3 113 of the network 100. Node 6 106, node 7 107, node 8 108, and node 9 109 may be viewed as being nodes on a backbone 99, wherein the backbone 99 is responsible for distributing information between areas.

Network nodes 101-110 may be equipped with appropriate hardware, firmware, or software to communicate information in accordance with one or more protocols. A protocol may comprise a set of instructions by which the information is communicated over the communications medium. Protocols are, furthermore, often layered over one another to form something called a “protocol stack.” In an embodiment of the invention, the network nodes 101-110 operate in accordance with an OSPF protocol stack utilizing TCP/IP.

The nodes 101-110 may be source nodes, destination nodes, intermediate nodes or a combination of those source nodes, destination nodes and intermediate nodes. Information is transmitted across the network 100 from source nodes to destination nodes, often through one or more intermediate nodes. Routers are a type of node that generally determine how information is to be routed from source nodes to destination nodes. Routers also commonly act to receive and transmit information.

Information may comprise any data capable of being represented as a signal, such as an electrical signal, optical signal, acoustical signal and so forth. Examples of information in this context may include data related to emails, web pages, IP phone calls, audio-visual and so forth.

Nodes may include a processor or a computer coupled to a network such as, for example, the Internet.

In an embodiment, a table maintenance system as described herein may operate in a router, such as for example, node 6 106 as it transmits information from a transmitting node such as node 1 101 to a receiving node such as node 10 110.

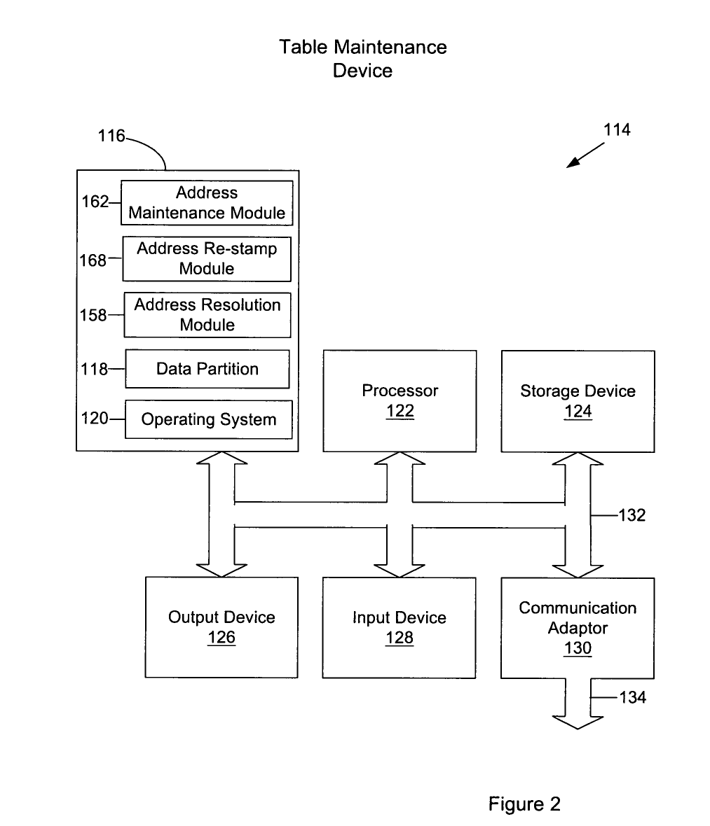

FIG. 2 illustrates a table maintenance device 114 in an embodiment in which address table maintenance is performed in a router or switch. That table maintenance device 114 includes memory 116, a processor 122, a storage device 124, an output device 126, an input device 128, and a communication adaptor 130. It should be recognized that any or all of the components 114-134 of the table maintenance device 114 may be implemented in a single machine. For example, the memory 116 and processor 122 might be combined in a state machine or other hardware based logic machine. Communication between the processor 122, the storage device 124, the output device 126, the input device 128, and the communication adaptor 130 may be accomplished by way of one or more communication busses 132. It should be recognized that the table maintenance device 114 may have fewer components or more components than shown in FIG. 2. For example, if a user interface is not desired, the input device 128 or output device 126 may not be included with the table maintenance device 114.

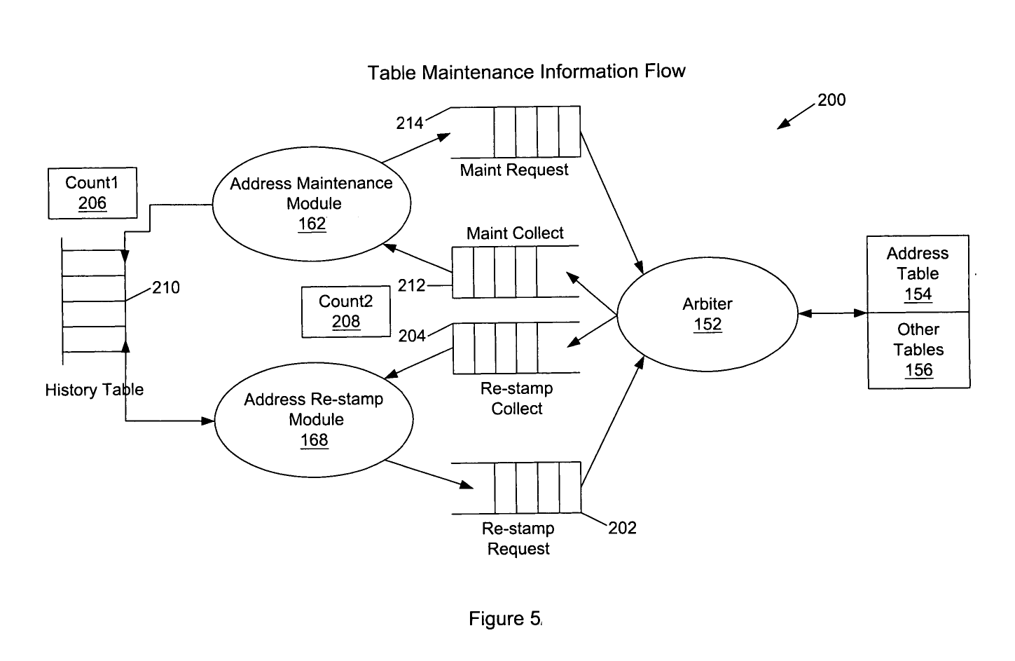

The memory 116 may, for example, include random access memory (RAM), dynamic RAM, and/or read only memory (ROM) (e.g., programmable ROM, erasable programmable ROM, or electronically erasable programmable ROM) and may store computer program instructions and information. The memory 116 may furthermore be partitioned into sections in which operating system 120 instructions are stored, a data partition 118 in which data is stored, an address resolution module 158 in which instructions for reading addresses for transmitting or receiving entities may be stored, an address maintenance module 162 in which instructions for adding or deleting addresses from an address table may be stored, and an address re-stamp module 168 in which instructions for writing stamps to the address table when an address is accessed are stored. The address resolution module 158, address maintenance module 162, and address re-stamp module 168 may also allow execution by the processor 122 of the instructions to perform their respective functions. The data partition 118 may furthermore store data to be used during the execution of the program instructions such as, for example, a history table 210, request FIFO table 202 or a collect FIFO table 208, as shown on FIG. 5.

The processor 122 may, for example, be an Intel® Pentium® type processor or another processor manufactured by, for example Motorola®, Compaq®, AMD®, or Sun Microsystems®. The processor 122 may furthermore execute the program instructions and process the data stored in the memory 116. In one embodiment, the instructions are stored in memory 116 in a compressed and/or encrypted format. As used herein the phrase, “executed by a processor” is intended to encompass instructions stored in a compressed and/or encrypted format, as well as instructions that may be compiled or installed by an installer before being executed by the processor.

The storage device 124 may, for example, be a magnetic disk (e.g., floppy disk and hard drive), optical disk (e.g., CD-ROM) or any other device or signal that can store digital information. The communication adaptor 130 may permit communication between the table maintenance device 114 and other devices or nodes coupled to the communication adaptor 130 at the communication adaptor port 134. The communication adaptor 130 may be a network interface that transfers information from nodes on a network such as the network 100 of FIG. 1, to the table maintenance device 114 or from the table maintenance device 114 to nodes 101-110 on the network 100. The network in which the table maintenance device 114 operates may be the network 100 of FIG. 1, or a local or wide area network, such as, for example, the Internet or the World Wide Web. It will be recognized that the table maintenance device 114 may alternately or in addition be coupled directly to one or more other devices through one or more input/output adaptors (not shown).

The table maintenance device 114 may also be coupled to one or more output devices 126 such as, for example, a monitor or printer, and one or more input devices 128 such as, for example, a keyboard or mouse. It will be recognized, however, that the table maintenance device 114 does not necessarily need to have an input device 128 or an output device 126 to operate. Moreover, the storage device 124 may also not be necessary for operation of the table maintenance device 114.

The elements 114, 122, 124, 126, 128, and 130 of the table maintenance device 114 may communicate by way of one or more communication busses 132. Those busses 132 may include, for example, a system bus, a peripheral component interface bus, and an industry standard architecture bus.

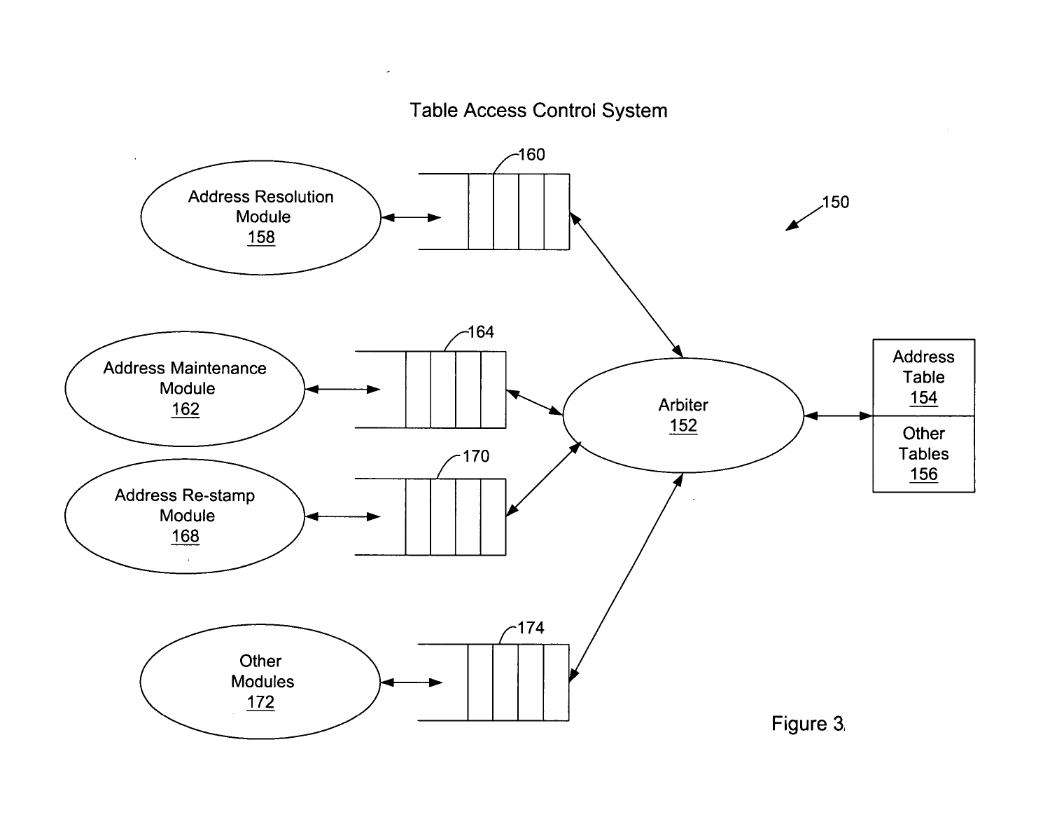

FIG. 3 illustrates an address table access control system 150 in which an arbiter 152 is included to control module access to an address table 154 and other tables 156, where those other tables 156 exist. The arbiter 152 may assure that desired latency requirements are met in its control of access to the address table 154 and the other tables 156 and thereby avoid resource contention between modules 158, 162, 168, 172 desiring access to the address table 154 and the other tables 156.

The other tables 156 may, for example, include ACL rules or VLAN entries that are stored in the same memory as the address table 154. Thus, it may be desirable to control all access to the commonly used memory through the arbiter 152.

In FIG. 3, an address resolution module communicates resolution information 160 to or from the arbiter 152, an address maintenance module 162 communicates maintenance information 164 to or from the arbiter 152, and address re-stamp module 168 communicates re-stamp information 170 to or from the arbiter 152, and other modules 172 may also communicate other information 174 to or from the arbiter 152.

The arbiter 152 will, in turn, service requests from the modules 158, 162, 168, and 172 to prevent contention between the modules as they request access to the tables 154 and 156 in the common memory, while attaining appropriate or desired levels of latency for those access requests.

Locking mechanisms may be used to control access to common memory by multiple modules. With such locking mechanisms, however, only the module that is currently accessing the memory has access to that memory. That can lead to greater than desired latency for modules that have their access locked out when, for example, a lower priority access is taking place. Latency may also become indeterministic when, for example, desired module latency varies due, for example, to a growing queue in a module. For example, it may be desired to increase the priority of a low priority module when the queue containing access to be performed in that module grows to a greater than desired size. Thus, priority inversion, wherein one or more lower priority access are performed while lower priority access are waiting in a queue, may occur when utilizing locking mechanisms, resulting in timing of events being unpredictable. Such priority inversions, between the address table maintenance module 162 and the address table re-stamp module 168 or between the address resolution module 160 and the address table re-stamp module 168, for example, are likely to occur when utilizing locking mechanisms.

In an embodiment, the arbiter 152 maintains a history of operations queued for performance on the address table 154. That history may be maintained in a history table and that history table may be stored in a location other than the memory in which the address table 154 and other tables 156 are stored so as not to create additional conflicts. That history table may be used to predict whether the address table will be modified before a current write operation to the address table may be completed.

The history table may be a first-in-first-out (FIFO) type table that may have a fixed number of entries. The history table may also be configured to include only write operations performed on the address table 154 because write operations modify the address table 154, while read operations do not modify the address table 154. The history table may furthermore include only write operations that are currently pending execution, removing entries that have already been performed, because the goal of the history table is to predict whether the address table will be modified before the current write operation is completed and write operations that have already been completed cannot interfere with a write operation that is about to take place. Alternately, the history table may be of predetermined size, with new entries entering at a “top” of the history table and oldest entries being removed from a “bottom” of the history table each time a new entry is added. An address maintenance system may then consider all entries in the history table. A method by which a relevant portion of the history table may be determined may also be used as an alternative in a fixed size history table. An example of such a method of determining a relevant portion of a fixed size history table is provided in connection with FIG. 5.

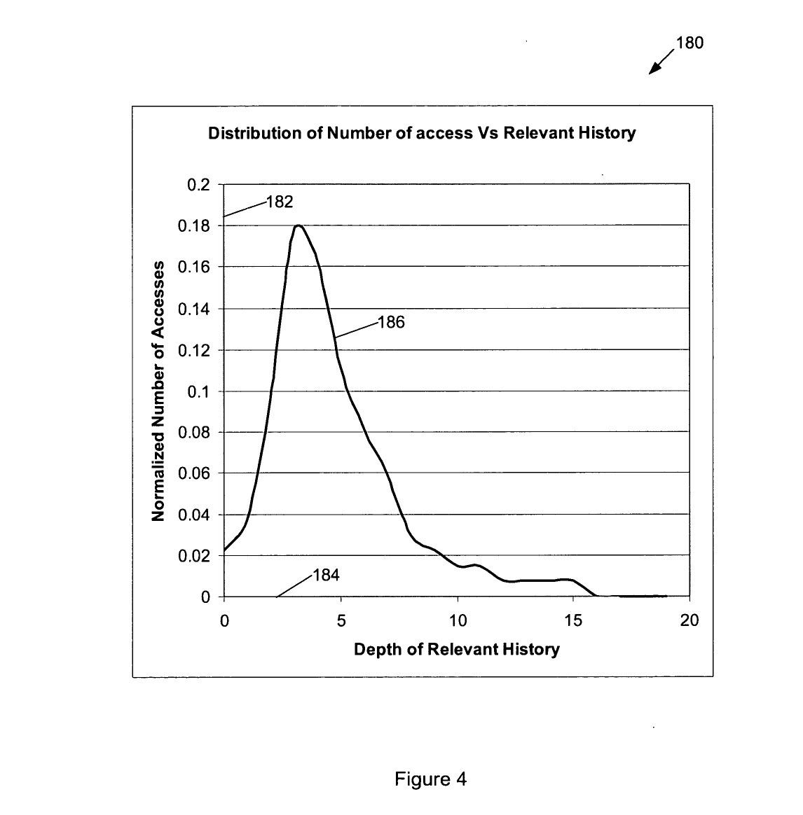

FIG. 4 is a relevant history chart 180 that illustrates a number of entries that were relevant for an IXE2424™ Intel® media switch as determined during test operation of such a switch. The IXE2424™ media switch is an application specific integrated circuit (ASIC), designed to facilitate the design of high port density, high-performance, and media-ready Fast Ethernet switching systems. That media switch supports one write request for every twelve read requests. It should be noted that the address table management systems, devices, and methods described herein may be utilized in connection with devices other than the IXE2424™ media switch.

The relevant history chart 180 of FIG. 4, illustrates a normalized distribution of a number of accesses versus a number of historic operations that are relevant. The normalized number of accesses are illustrated on the vertical axis 182 and the number of historic entries that are relevant are illustrated on the horizontal axis 184. As may be seen by reference to the graph 186, most write accesses need to reference to a depth of only four historic write operations to have all information necessary to make a prediction regarding whether the address table 154 is likely to be modified before the current write operation is completed, and almost all write accesses may be assured of having a sufficient depth of historic information to determine whether the address table 154 is likely to be modified before the current write operation is completed with a depth of sixteen historic write operations available in the history table. It should be noted that it would be expected that the graph 186 would change for a device having a different ratio of read to write operations or if the time required to perform a write operation varies from that of the IXE2424™ media switch. It should be true in most or all cases, however, that a small depth of history in a history table will be appropriate for operation of the address table access control system 150.

A system is contemplated having a history table, a first counter, a second counter, and at least one write module. The history table is used to store pieces of information transmitted to a target table in an order in which they are received. Those pieces of information may furthermore be write requests posted to the target table by the module or modules. The first counter is incremented when each piece of information to be written to the target table is transmitted to the target table and the second counter to increment when each piece of information is written to the target table. Thus the difference between the second counter and the first counter is equal to the number of pending write requests that have not yet been written to the target table and that difference may be referred to as a pending count. The pending counter may be applied to the history table such that the pieces of information most recently received by the history table, up to pending count, would be the pieces of information that are pending to be written to the target table. The write module may then consider the locations to which the pending pieces of information are to be written to determine if any one or more of those locations match the location to which a current write request is to be written. The write module may then transmit the current write request to the target table if none of the locations to which the pending entries are to be written match the location to which the current write request is to be written and may not transmit the current write request to the target table if any one or more of the locations to which the pending entries are to be written match the location to which the current write request is to be written.

A method is also contemplated. That method includes storing write requests transmitted to a target table in order of receipt, counting a number of write requests transmitted to the target table, counting a number of write requests written to the target table, determining a difference between the first counter and the second counter, reading from the stored write requests locations to which a number of most recently transmitted write requests corresponding to pending counter will be written, and determining whether any of those locations match the location to which a current write request is to be written.

Once it is determined whether the current write request will be written to the same location as a pending write request, then the method may continue by transmitting the current write request to the target table if none of the locations to which the number of most recently transmitted write requests corresponding to pending counter will be written match the location to which the current write request is to be written and by not transmitting the current write request to the target table if any one of the locations to which the number of most recently transmitted write requests corresponding to pending counter will be written match the location to which the current write request is to be written.

An article of manufacture having a computer readable medium having stored thereon instructions which, when executed by a processor, cause the processor to perform those actions is also contemplated.

In addition, a router is contemplated. The router includes a communication adaptor coupled to a network to receive information from a transmitting node and transmit that information to a receiving node. The router also includes memory and a module that transmits write requests to the memory. The memory stores a target table, a request table, a request counter, and a collect counter. The target table may be consulted to resolve an address of the receiving node from information included in a transmission received from the transmitting node. The request table contains write requests transmitted to the address resolution table and the collect table contains completed write requests. The request counter increments each time a write request is transmitted to the target table and the collect counter increments each time a write request is written to the target table.

FIG. 5 illustrates an implementation of an address table access control system 200. The embodiment illustrated in FIG. 5 illustrates operation of an address maintenance module 162 and an address re-stamping module 168 to explain the operation of the address table access control system 200, however, it should be recognized that the address table access control system 200 may operate on additional modules including, for example, an address resolution module 158 and other modules 172.

As shown in FIG. 5, requests from the address maintenance module 162 for the address table 154 may be transmitted from the address maintenance module 162 to a table such as a maintenance request FIFO table 214 and also to the history table 210. Information returned from the address table 154, may pass through the arbiter 152 and be placed in a table such as a maintenance collect FIFO table 212.

Similarly, requests from the address re-stamp module 168 for the address table 154 may be transmitted from the address re-stamp module 168 to a table such as a re-stamp request FIFO table 202 and also to the history table 210. Information returned from the address table 154, may pass through the arbiter 152 and be placed in a table such as a re-stamp collect FIFO table 204.

Each time a module such as the address maintenance module 162 or the address re-stamp module 168 adds a write request to a table 202 and 214, that write request may also be added to the history table 210 and Count1 206 may be incremented. Count2 208 is another counter that may be incremented whenever a write operation to the address table 154 is completed. The difference between the value of Count1 206 and Count2 208, which may be referred to as a pending count, is then the number of write operations pending to be performed on the address table 154.

To inform the address re-stamp module 168 of the value of Count2 208, the value of Count2 208 may be stamped on entries or information sent from the arbiter 152 to a module such as the address re-stamp module 168 or the address maintenance module 162. As illustrated in FIG. 5, the information stamped with the number of completed write operations may be held in entries in the re-stamp collect table 204, the maintenance collect table 212, and any other similar tables utilized by other modules. The modules 162 and 168 may then read the information stamped on the entries from the collect tables 204 and 212 and parse the number of completed write operations from those stamps.

Once the number of pending write operations has been determined, those pending write operations may be examined by a module such as the address re-stamp module 168 or the address maintenance module 162. The most recent entries in the history table 210 up to the number of pending write operations, which may be envisioned as the “top” most entries in the history table, will be those pending write operations. Thus, a module such as the address re-stamp module 168 or the address maintenance module 162 may consider the memory locations that are to be modified by the pending write operations to determine whether any current write request that the module 162 or 168 desires to write would be written to the same memory location to which any pending write operation is to write.

If the memory location that the current write operation intends to modify is not the same as the memory location that any pending write operation in a queue of write operations is to modify, then the current write request may be posted to the write history table 210 and the appropriate request table 202 or 214 so that write operation may performed by the arbiter 152 on the address table 154 when appropriate.

If the memory location that the current write operation intends to modify is the same as the memory location that any pending write operation in a queue of write operations is to modify, then the current write request may not be posted to the write history table 210 or either request table 202 or 214 so that the write operation will not be performed on the address table 154.

In the case where the memory locations to be modified are part of an address table 154, and the current write operation is not to be posted to the write history table 210 or either request table 202 or 214, the current write operation may be discarded. A reason that a current write operation may simply be discarded when working with an address table 154 is that typically additional duplicate write operations that are the same as the current operation will be received from the address re-stamp module 168 or the address maintenance module 162 in a very short time. To explain why a write may be discarded in the realm of an address table 154, it may be recognized that entries in an address table are typically aged out or removed from the address table if they have not been used for a predetermined period of time. Use of each transmitting address is typically confirmed by writing a stamp to each entry in the address table each time that a packet from the transmitting node corresponding to that transmitting address is received. Moreover, since many transmissions involve transmission of a large number of packets, a write command stamping an entry typically occurs for every packet transmitted. Therefore, address re-stamping usually occurs frequently during a transmission that involves many packets and skipping one of those re-stamp writes, or even a few of those re-stamp writes is of little consequence.

If the pending counter is greater than the number of entries held in the history table 210, write requests may be discarded and not posted to the history table 210 or the request tables 202 or 214 because it is not safe to perform that write when it cannot be assured that no pending write operations will conflict with the current write request.

Alternately, rather than discarding a conflicting write request, that conflicting write request could be transferred to another module that may, for example, determine a location of the entry to be modified by the write request, recognizing that the location of the entry may have changed due to another write operation, and cause the write to be performed at that location at a time when the conflict no longer exists.

While the systems, apparatuses, and methods of table maintenance have been described in detail and with reference to specific embodiments thereof, it will be apparent to one skilled in the art that various changes and modifications can be made therein without departing from the spirit and scope thereof. Thus, it is intended that the table maintenance cover modifications and variations provided they come within the scope of the appended claims and their equivalents.

1. A system, comprising:
a history table to store pieces of information transmitted to a target table in order of receipt;
a first counter to increment when each piece of information to be written to the target table is transmitted to the target table;
a second counter to increment when each piece of information is written to the target table; and
a write module to set a pending counter to a difference between the first counter and the second counter, read locations to which a number of most recently written pieces of information in the history table equal to pending counter will be written, and determine whether any of those locations match the location to which a current write request is to be written.

2. The system of claim 1, wherein the target table is an address table.

3. The system of claim 1, wherein a plurality of pieces of information are transmitted to be written to the first table and each of that plurality of pieces of information is written to the first table.

4. The system of claim 1, further comprising an arbiter to receive the plurality of pieces of information to be written to the target table, write each piece of information to the target table at a time after each piece of information is received, and transmit data to the module indicating that each write request has been written to the target table.

5. The system of claim 1, wherein the pieces of information are written to the target table in the order those pieces of information were transmitted to the target table.

6. The system of claim 1, further comprising a second write module also to set the pending counter to a difference between the first counter and the second counter, read locations to which a number of most recently written pieces of information in the history table equal to pending counter will be written, and determine whether any of those locations match the location to which a current write request is to be written concurrently with the write module.

7. The system of claim 6, wherein each piece of information to be written to the target table is transmitted from either the write module or the second write module.

8. The system of claim 1, wherein the most recently written entries in the history table, to a number of entries corresponding to the pending counter, are pending entries.

9. The system of claim 8, wherein the write module is to transmit the current write request to the target table if none of the locations to which the pending entries are to be written match the location to which the current write request is to be written.

10. The system of claim 8, wherein the write module is not to write the current write request to the target table if any of the locations to which the pending entries are to be written match the location to which the current write request is to be written.

11. The system of claim 8, wherein the write module is to discard the current write request to the target table if any of the locations to which the pending entries are to be written match the location to which the current write request is to be written.

12. A method, comprising:
storing write requests transmitted to a target table in order of receipt;
counting a number of write requests transmitted to the target table;
counting a number of write requests written to the target table;
determining a pending counter that is equal to a difference between the number of write requests transmitted to the target table and the number of write requests written to the target table;
reading from the stored write requests locations to which a number of most recently transmitted write requests corresponding to pending counter will be written; and
determining whether any of those locations match the location to which a current write request is to be written.

13. The method of claim 12, further comprising transmitting the current write request to the target table if none of the locations to which the number of most recently transmitted write requests corresponding to pending counter will be written match the location to which the current write request is to be written.

14. The method of claim 12, further comprising not transmitting the current write request to the target table if any one of the locations to which the number of most recently transmitted write requests corresponding to pending counter will be written match the location to which the current write request is to be written.

15. The method of claim 14, further comprising discarding the current write request.

16. An article of manufacture comprising:
a computer readable medium having stored thereon instructions which, when executed by a processor, cause the processor to:
store write requests transmitted to a target table in order of receipt;
count a number of write requests transmitted to the target table;
count a number of write requests written to the target table;
calculating a pending counter that is equal to a difference between the first counter and the second counter;
read from the stored write requests locations to which a number of most recently transmitted write requests corresponding to pending counter will be written; and
determine whether any of those locations match the location to which a current write request is to be written.

17. The method of claim 16, wherein the computer readable medium further causes the processor to transmit the current write request to the target table if none of the locations to which the number of most recently transmitted write requests corresponding to pending counter will be written match the location to which the current write request is to be written.

18. The method of claim 16, wherein the computer readable medium further causes the processor not to transmit the current write request to the target table if any one of the locations to which the number of most recently transmitted write requests corresponding to pending counter will be written match the location to which the current write request is to be written.

19. The method of claim 18, wherein the computer readable medium further causes the processor to discard the current write request.

20. A router, comprising:
a communication adaptor coupled to a network to receive information from a transmitting node and transmit that information to a receiving node;
memory to store a target table containing information that resolves an address of the receiving node from information included in a transmission received from the transmitting node, a request table containing write requests transmitted to the address resolution table, a collect table containing completed write requests, a request counter to increment each time a write request is transmitted to the target table, and a collect counter to increment each time a write request is written to the target table;
a module coupled to the memory to calculate a pending counter equal to the request counter less the collect counter, determine locations in the target table to which a number of most recent write requests contained in the request table corresponding to pending counter are to be written, determine whether at least one of the determined locations matches a location to which a current write request is to be written, transmit the current write request to the target table if none of the locations to which the pending entries are to be written match the location to which the current write request is to be written, and not write the current write request to the target table if any of the locations to which the pending entries are to be written match the location to which the current write request is to be written.

21. The router of claim 20, wherein the target table is an address resolution table.

22. The router of claim 20, wherein the current write request is discarded if any of the locations to which the pending entries are to be written match the location to which the current write request is to be written.
